(19) United States
(12) Patent Application Publication
(10) Pub. No.: US 2026/0070551 A1
(43) Pub. Date: Mar. 12, 2026

(54) METHOD AND SYSTEM FOR ACTIVE CONTROL OF VARIABLE SPEED LIMITS ON HIGHWAYS

(71) Applicant: CHANG'AN UNIVERSITY, Xi'an (CN)

(72) Inventors: Xia WU, Xi'an (CN); Yan WANG, Xi'an (CN); Xiangmo ZHAO, Xi'an (CN); Haigen MIN, Xi'an (CN); Siyuan GONG, Xi'an (CN); Jiadong LI, Xi'an (CN); Dengrong LI, Xi'an (CN); Jiawei LU, Xi'an (CN); Dongbao HAO, Xi'an (CN); Jiahuan ZHANG, Xi'an (CN); Jingjie XIA, Xi'an (CN); Zhanliang CHEN, Xi'an (CN); Shaoxuan ZHENG, Xi'an (CN); Fangcheng YU, Xi'an (CN)

(21) Appl. No.: 19/390,474

(22) Filed: Nov. 14, 2025

(30) Foreign Application Priority Data
Nov. 15, 2024 (CN) 202411637612.1

(51) Int. Cl. B60W 30/14; B60W 50/00; B60W 60/00

(52) U.S. Cl. CPC B60W 30/143; B60W 50/0097; B60W 60/001; B60W 2050/0022; B60W 2552/05; B60W 2552/10; B60W 2554/406; B60W 2555/60; B60W 2556/45; B60W 2720/10

(57) ABSTRACT

A method for active control of variable speed limits on highways includes: (a) a mixed traffic flow scenario considering driver individuality is constructed, and scenario parameters are set; (b) traffic state data for a merging road scenario is acquired; (c) an agent is trained using the traffic state data as state variables to obtain a speed limit control optimization model; diverse training scenarios are generated by Poisson distribution during training, an optimal speed limit value and an appropriate speed control location are selected within each control cycle T, and a moving bottleneck is generated using a moving bottleneck variable speed limit constructed based on connected and autonomous vehicles. A system for active control of variable speed limits on highways is further provided.

### CROSS-REFERENCE TO RELATED APPLICATIONS

This application claims the benefit of priority from Chinese Patent Application No. 202411637612.1, filed on Nov. 15, 2024. The content of the aforementioned application, including any intervening amendments made thereto, is incorporated herein by reference in its entirety.

### TECHNICAL FIELD

This application relates to intelligent transportation, and more particularly to an active control method and system for variable speed limits (VSL) on highways.

### BACKGROUND

VSL control is a common traffic management method in highway systems. Its core principle involves the control center calculating different speed limit values for various time periods based on factors such as traffic detection data and road conditions. The calculated speed limit values are then transmitted to variable speed limit signs along the highway, dynamically adjusting speed limits on the main lane to increase traffic throughput, shorten travel times, and reduce accident rates.

However, traditional control methods have numerous drawbacks. For example, they rely solely on fixed detectors to monitor traffic flow data, and the analysis of historical data fails to reflect the real-time dynamics of traffic conditions. Additionally, drivers' individual characteristics result in different reactions and driving strategies, which, in turn, impact the effectiveness of the control strategies to varying degrees.

### SUMMARY

To address the deficiencies in prior art, this application provides a method and system for active control of VSL on highways, which overcomes issue of the existing methods that cannot fully comply with speed limit regulations, and exhibits superior performance in both safety and traffic efficiency.

Technical solutions of the present disclosure are described as follows.

In a first aspect, this application provides a method for active control of variable speed limits on highways, comprising:
(a) constructing a mixed traffic flow scenario that accounts for driver individuality and setting scenario parameters;
(b) based on the mixed traffic flow scenario, acquiring traffic state data for a merging road scenario, comprising an on-ramp and upstream and downstream areas of a main lane; and
(c) training an agent using the traffic state data as state variables to obtain a speed limit control optimization model, wherein diverse training scenarios are generated by Poisson distribution during training, an optimal speed limit value and an appropriate speed control location are selected within each control cycle T, and a moving bottleneck is generated using a moving bottleneck variable speed limit (MVSL) constructed based on connected and autonomous vehicles (CAVs).

In an embodiment, density and flow data in a merging area are acquired based on the mixed traffic flow scenario to plot a flow-density diagram, which is used as a basis for determining traffic congestion in road sections within the merging area.

In an embodiment, traffic state data of an entire roadway are acquired by using a road network perception module, the road network perception module comprises an area detector, a point detector, and a cloud control center; the area detector and the point detector are configured to receive vehicle information and road status information, and to upload the vehicle information and road status information to the cloud control center; and the cloud control center is configured to convert list data into an array format and transmit the array format to a control model.

In an embodiment, the traffic state data comprises vehicle travel paths, the number of lanes, and traffic volume, and the vehicle travel paths comprise two paths: a path on the main lane and a path from the on-ramp to the main lane.

In an embodiment, step of “the optimal speed limit value and the appropriate speed control location are selected within each control cycle T” comprises:
identifying, at a starting position of a control zone, leading CAVs in different lanes that satisfy predetermined conditions; and
instructing two of the leading CAVs to travel according to fixed speed limit values v_{TV} and v_{OV}.

In an embodiment, the speed limit control optimization model comprises a hybrid reward function considering traffic efficiency and safety, expressed as reward=w×V⁻+(1−w)×(TTC)⁻, wherein w represents a weight for traffic efficiency, V⁻ represents an average normalized speed in a bottleneck area, and (TTC)⁻ represents an average normalized time-to-collision of vehicles in the bottleneck area.

In an embodiment, during training of the speed limit control optimization model, a Critic network and Actor networks are constructed; wherein one Critic network is provided, and the number of the Actor networks are three, and an activation function of each Actor network is modified to a Tanh function to limit an action value output range to [−1, 1]; and

wherein road state information is input to the Critic network; within each control cycle T, each independent agent makes a decision control by observing local state; a centralized Critic network is configured to employ a normalized advantage function estimation method to estimate a common action based on reward values obtained from action trajectories of each agent during centralized training; and each agent i selects an optimal action a_{T+1}ⁱ for a next control cycle T+1 by inputting a state value estimated by the Critic network into a corresponding Actor network.

In a second aspect, this application provides a system for active control of variable speed limits on highways, comprising:
a scenario construction module;
a traffic state acquisition module; and
a control module;
the scenario construction module is configured to construct a mixed traffic flow scenario that accounts for driver individuality and set scenario parameters;
the traffic state acquisition module is configured to acquire traffic state data for a merging road scenario comprising an on-ramp and upstream and downstream areas of a main lane based on the mixed traffic flow scenario; and
the control module is configured to train a control model by using the traffic state data as state variables, and simultaneously train an agent based on real-time road traffic states to obtain an optimization model, wherein diverse training scenarios are generated by Poisson distribution during training, an optimal speed limit value and an appropriate speed control location are selected within each control cycle T, and a moving bottleneck is generated using a MVSL constructed based on CAVs.

In a third aspect, this application provides a computer device, comprising:
a memory;
a processor, and
a computer program;
wherein the computer program is stored in the memory and configured to be operated on the processor; and the processor is configured to execute the computer program to implement the method above.

In a fourth aspect, this application provides a computer-readable storage medium, wherein a computer program is stored on the computer-readable storage medium; and the computer program is configured to be executed by a processor to implement the method above.

Compared to the prior art, the present disclosure has the following beneficial effects.

(1) This application provides a method for active control of variable speed limits on highways includes: (a) a mixed traffic flow scenario considering driver individuality is constructed, and scenario parameters are set; (b) traffic state data for a merging road scenario is acquired based on the mixed traffic flow scenario; (c) a control model by using the traffic state data as state variables, and simultaneously an agent is trained based on real-time road traffic states to obtain an optimization model; diverse training scenarios are generated by Poisson distribution during training, an optimal speed limit value and an appropriate speed control location are selected within each control cycle T, and a moving bottleneck is generated using a MVSL constructed based on CAVs. A system for active control of variable speed limits on highways is further provided. By actively constructing moving bottleneck, traffic conditions are optimized in terms of both safety and traffic efficiency.

This application focuses on only controlling a small number of CAVs as the primary control objects and actively controlling CAVs to form moving bottlenecks as a speed limit control measure. The application employs proximal policy optimization (PPO) as algorithmic foundation and extends this to multi-agent reinforcement learning, thereby training the speed limit control strategy based on a fully cooperative relationship model among multiple agents. The application designs a hybrid reward function aiming to optimize traffic efficiency and ensure road traffic safety, thereby improving traffic performance.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram illustrating active moving bottleneck formation for speed limit control on a smart highway according to an embodiment of the present disclosure;

FIGS. 2a and 2b show vehicle distributions in VSL traffic flow according to an embodiment of the present disclosure;

FIGS. 3a and 3b show a fundamental diagram of traffic flow scenario construction according to an embodiment of the present disclosure;

FIG. 4 shows interaction between multi-agent reinforcement learning and environment according to an embodiment of the present disclosure;

FIG. 5 shows change in reward values before and after variable speed limit control according to an embodiment of the present disclosure;

FIGS. 6a and 6b illustrate change in average speed in the bottleneck area before and after variable speed limit control according to an embodiment of the present disclosure;

FIGS. 7a-7c illustrate distribution of average speed changes within 500 m intervals in bottleneck area before and after variable speed limit control according to an embodiment of the present disclosure;

FIGS. 8a and 8b illustrate average time-to-collision of vehicles in the bottleneck area before and after variable speed limit control according to an embodiment of the present disclosure; and

FIG. 9 is a flowchart of an active control method for variable speed limit on highways according to an embodiment of the present disclosure.

### DETAILED DESCRIPTION OF EMBODIMENTS

The present disclosure will be described in detail below with reference to the accompanying drawings and embodiments. The embodiments described herein are only used to illustrate and explain the disclosure, which are not intended to limit the disclosure.

As used herein, orientation or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” are based on the orientations or positional relationships shown in the accompanying drawings. These terms are only for the convenience of describing the disclosure and simplifying the description, rather than indicating or implying that the indicated device or element must have a specific orientation, or be constructed or operated in a specific orientation. Therefore, these terms should not be understood as a limitation of the present disclosure.

In addition, the terms “first” and “second” are merely descriptive, and cannot be understood as indicating or implying relative importance, or implying the number of indicated technical features. The terms “first” and “second” indicate at least one of such features. The term “a plurality of” means two or more, unless expressly specified otherwise.

As used herein, terms, such as “installation”, “connection”, and “fixation”, should be understood in a broad sense, for example, the “connection” may be fixed connection, detachable connection, or integral connection; or mechanical connection, electrical connection, or communication links; or direct connection or indirect connection through an intermediate medium. For those skilled in the art, the specific meaning of the above terms can be understood according to specific situations.

As used herein, unless otherwise expressly specified and defined, a first feature being “on” or “under” a second feature may indicate direct contact between the first and second features, and may also indicate indirect contact through an intermediate feature between them. Moreover, a first feature being “above”, “over”, or “on” a second feature indicate the first feature being directly above or obliquely above the second feature, or simply indicates that the horizontal level of the first feature is higher than that of the second feature. A first feature being “below,” “under,” or “beneath” a second feature includes the first feature being directly below or obliquely below the second feature, or simply indicates that the horizontal level of the first feature is lower than that of the second feature.

It should be understood that as used herein, the terms “include” and “comprise” indicate the presence of the described features, entities, steps, operations, elements, and/or components, but do not exclude the presence or addition of one or more other features, entities, steps, operations, elements, components, and/or their combinations.

It should be understood that the terms used in the disclosure are used solely for describing specific embodiments and are not intended to limit the disclosure. As used herein, unless otherwise expressly specified and defined, the singular forms “one”, “a” and “the” are intended to include the plural forms.

As used herein, the term “and/or” refers to all possible combinations of one or more of the items listed and includes those combinations.

Various schematic diagrams are shown in the accompanying drawings according to embodiments of the present disclosure. These drawings are not to scale; certain details have been enlarged and may have been omitted for clarity. The shapes of the various regions and layers shown in the drawings and the relative size and position relationships between them are only exemplary and may deviate due to manufacturing tolerances or technical limitations in practice. The person skilled in the art may additionally design regions/layers with different shapes, sizes, and relative positions depending on actual demand.

The embodiments of the present disclosure will be described in detail below with reference to the accompanying drawings.

An active control method for VSL on highways provided herein actively controls CAVs to form moving bottlenecks as variable speed limit controls within mixed traffic flow environments. Its implementation is based on a multi-agent PPO algorithm and utilizes multi-agents to learn driver behavior characteristics applied to CAVs to alleviate congestion in merging areas. The method specifically includes the following steps:

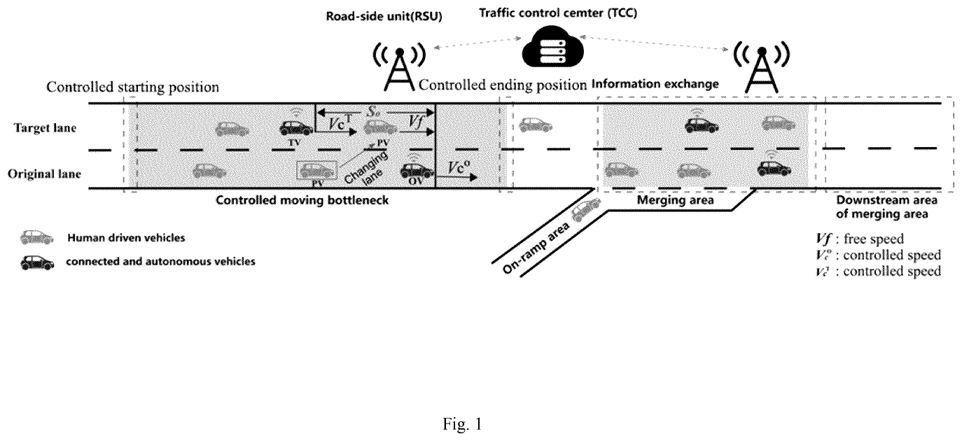

S1. A mixed traffic flow scenario considering driver individuality is constructed. Vehicle types specifically include human driven vehicles (HDVs) and CAVs, with detailed parameter information for different vehicles provided in Table 1. In this embodiment, as shown in FIG. 1, the main lane in the traffic scenario is designed as a two-lane roadway including a single on-ramp (single-entrance ramp), and divides the roadway into a controlled moving bottleneck zone, a merging area, and a downstream area of the merging area.

Traffic flow generation: to ensure scenario plausibility, the traffic flow is divided into three phases: a warm-up phase, a build-up phase, and a recovery phase.

TABLE 1
Personalized vehicle parameter definitions

| | | | Car- | | | |
|---|---|---|---|---|---|---|
| | | Vehicle | follow- | Accelera- | Decelera- | Reac- |
| | Minimum | length | ing | tion | tion | tion |
| Type | gap (m) | (m) | model | (m/s²) | (m/s²) | time (s) |
| HDV1 | 2.5 | 3.5 | Krauss | 2.6 | 4.5 | 2 |
| HDV2 | 2 | 3.5 | W99 | 2 | 5 | 1.4 |
| HDV3 | 3 | 7 | W99 | 1.5 | 3.5 | 1.5 |
| CAV | 1.4 | 3.5 | IDM | 3 | 5.5 | 1 |

During training, 300 random scenarios are generated according to Poisson distribution, of which 250 are used for training.

Density and flow data in the merging area are acquired to plot a flow-density diagram, which serves as the basis for determining traffic congestion on roads in the merging area. In the mixed traffic flow scenario, the car-following model for vehicles is intelligent driver model (IDM), with 80% of vehicles as cars and 20% as trucks.

S2. The information perception module (namely, road network perception module) includes point detectors, area detectors, and a traffic control unit. The information perception module is configured to acquire the number of lanes, speed limit values, traffic paths, and traffic volume in the bottleneck area sections, and real-time lane occupancy rate for each lane in the bottleneck area, downstream sections, and the single on-ramp, as well as the average speed in the bottleneck area.

S3. MVSL is constructed. Unlike traditional variable speed limit control that relies on traffic information signs, the MVSL uses CAVs as control objects to form the control zone and generate the moving bottleneck.

S4. A multi-agent control model (multi-agent proximal policy optimization (MAPPO)) is constructed by setting hyperparameters, and establishing an input state space, an action space, and reward functions. The multi-agent control model adopts a fully cooperative control relationship and is specifically divided into three agents: two agents are responsible for controlling the speed of CAVs, while one agent is responsible for controlling the starting and ending positions of the speed limit control zone, and generates the moving bottleneck using MVSL. Algorithm training employs centralized training and decentralized decision-making framework. Specifically, each agent interacts with the environment, sharing perceived states to form a state set fed into the Critic network for training. Correspondingly, the Actor network for each agent executes distinct decision actions.

S5. The multi-agent control model is trained to obtain the optimal speed limit value and suitable control zones: the perceived data is input into the multi-agent training framework, and the constructed control model trains the three agents; based on the real-time state of the mixed traffic flow, actions of different agents within each control cycle T are obtained; these actions are then processed and converted into physical variables—speed and position—and issued to the controlled CAVs to regulate the mixed traffic flow.

S6. The control model loads applications, including loading the trained parameter model and conducting effectiveness test on generating multi-mixed traffic flow scenarios. The effectiveness testing covers two aspects: traffic efficiency and safety. Specific metrics include average speed in bottleneck areas and the average time-to-collision in bottleneck areas.

In step (S1) described above, HDVs are categorized into three types based on vehicle type, designated as [HDV1, HDV2, HDV3]. HDV3 represents trucks, and HDV1 and HDV2 represent cars. Based on driver behavior characteristics, they are classified into conservative and aggressive types: HDV1 is aggressive type, and HDV2 and HDV3 are conservative type.

In step (S1), the upstream area of the main lane has a total length of 7.5 km, the bottleneck area extends up to 1 km, the on-ramp is 500 m in length, and the downstream area of the bottleneck area is 2 km in length.

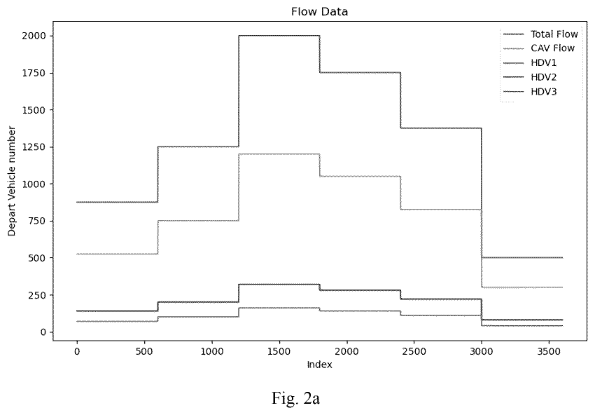

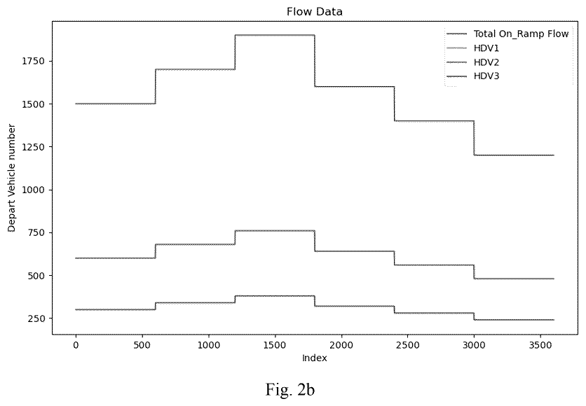

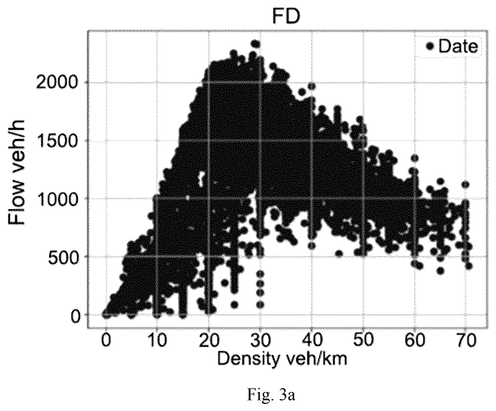

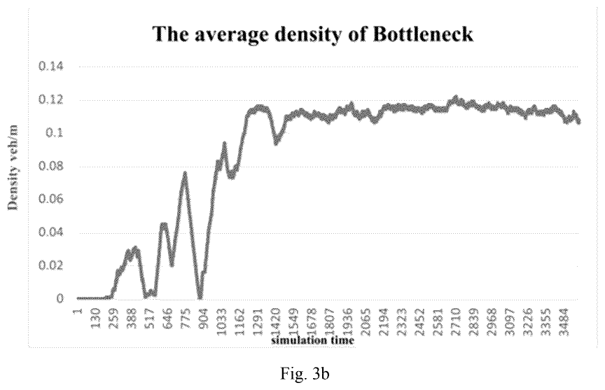

In step (S1), the traffic flow is divided into on-ramp flow and main lane flow, and vehicles are dispatched according to Poisson distribution at a set time. The set time in this embodiment is 600 time steps. Detailed dispatched vehicle counts and dispatch type proportions are shown in FIGS. 2a and 2b. The basic configuration of congestion scenarios and congestion zones is illustrated in FIGS. 3a and 3b.

Step (S2) includes the following steps.

Step 2-1: The highway section containing the on-ramp is divided into several areas. An area of the main lane at the merging point of the ramp and the main lane form a bottleneck area. Detectors receive all vehicle information and traffic state information of the vehicles passing through the areas of the main lane described in step (S1), and transmit the information to a cloud control center. The collected data includes real-time occupancy and average vehicle speed.

Step 2-2: Traffic state data is acquired. Road-side units are specifically deployed at three locations: the bottleneck area, the ramp entrance, and the downstream of the bottleneck area. The detectors are arranged in each lane at the bottleneck area, the downstream of the bottleneck area, and the ramp entrance, thereby obtaining real-time traffic flow data.

Step 2-3: The format of the traffic state data is converted. The control unit is a computer equipped with a standalone traffic control algorithm. The traffic control unit stores and transmits the data in an array format to the multi-agent training module.

In step (S3), the active formation algorithm of the moving bottleneck is detailed as follows. As shown in FIG. 1, the algorithm controls the longitudinal distance and constant speed of two CAVs (referred to as target vehicle (TV) and original vehicle (OV)). The moving bottleneck is formed by selecting CAVs in each lane, and these CAVs travel at different constant speeds. The longitudinal distance between the two CAVs provides space for the HDVs in the original lane to change lanes, enabling them to traverse the moving bottleneck and travel at the free-flow speed in the target lane.

In step (S3), the control zone location is provided by the MAPPO-MVSL algorithm, including the starting position and the ending position. The speed limit values for two leading CAVs are also provided by the speed limit algorithm, v_{VT} and v_{OV}. As mentioned in step (S1), the main road consists of two lanes. Specifically, the step of “selecting the optimal speed limit values and appropriate speed control positions within each control cycle T” can be described as: at the starting position of the control zone, finding leading CAVs in different lanes that satisfy predetermined conditions; and instructing two of the leading CAVs to travel according to fixed speed limit values v_{TV} and v_{OV}.

In step (S3), two CAVs maintain their original lanes without changing lanes during traveling. Control over this group of CAVs is deactivated when the controlled CAVs reach the end position of the control zone. If road congestion has not yet been fully alleviated, the algorithm continues to identify suitable CAVs at the starting position of the control zone within the control cycle T, until congestion in the bottleneck area dissipates.

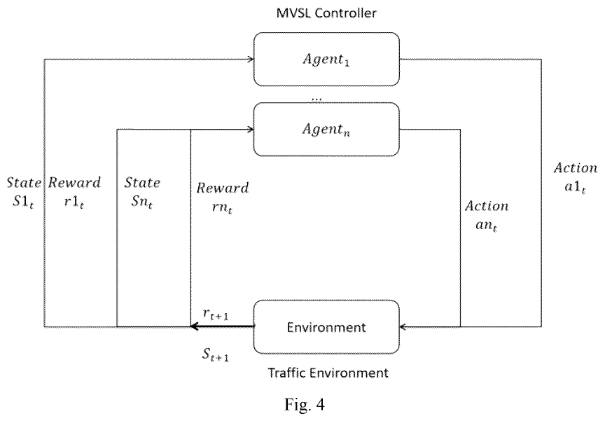

In step (S4), the MAPPO training module is constructed. As shown in FIG. 4, for the MAPPO training module, each agent selects an action a via the current old policy π_{T}^{old}, based on its observation o_{T}ⁱ in the current control cycle T. Upon executing a Tᵢ, the agent acquires the observation o_{T+1}ⁱ for the next cycle T+1. Each independent agent obtains a trajectory to compute a state value \hat{Q}ⁱ(s,a) and the advantage function Aⁱ(s,a). The trajectory data {zⁱ,aⁱ,\hat{Q}ⁱ(s,a),Aⁱ(s,a)} is then stored in an experience replay pool D. According to the number of times K needed to update the neural network, small batches are selected from the experience replay pool to compute the Actor network gradient and Critic network gradient for each agent i, and gradient ascent and gradient descent are applied respectively to update the network parameters.

Step (S4) described above includes the following steps.

Step 4-1: During training of the control model, two types of neural networks are constructed: the Critic network and the Actor network. Specifically, only one Critic network exists, while the number of Actor networks depends on the number of agents. In this embodiment, the number of the Actor networks are three. The activation function for each Actor network is changed to the Tanh function to limit the action value output range to [−1, 1].

Step 4-2: Road state information is input to the Critic network. Within each control cycle T, each independent agent makes decision control by observing local state. The centralized Critic network is configured to employ the normalized advantage function estimation method to estimate the common action based on reward values obtained from action trajectories of each agent during centralized training. Each agent i selects an optimal action a_{T+1}ⁱ for the next control cycle T+1 by inputting the state value estimated by the Critic network into a corresponding Actor network.

In step (S4), the parameters of the control model include number of iterations T=250, discount factor of 0.99, number of iterations per policy update of 15, learning rate of 0.0005, parameter λ for generalized advantage estimation (GAE) of 0.95, number of agents of 3; clipping parameter of 0.2; and episode steps per update of 15. Specific design details are shown in Table 2.

In step (S4), the state space includes the real-time occupancy rates per lane in the bottleneck area, the downstream of the bottleneck area, and the single-entrance ramp, the average speed in the bottleneck area; and a discrete variable for indicating road congestion status. This region describes the state of the MVSL, encompassing the merging area, the downstream area of the merging area, and the single-entrance ramp area. The lane occupancy sets for these three areas at each time step are defined as Oₜ^{m}, Oₜ^{dm}, and Oₜ^{r}, respectively. The average speed in the merging area is denoted by V̅_{b}, and D represents the variable used to determine whether congestion has formed in the current environment. Therefore, the state St can be defined as:

$${s}_{t} = [ {O}_{t}^{m} , {O}_{t}^{d m} , {O}_{t}^{r} , {\overline{V}}_{b} , D ] .$$

In step (S4), the MVSL controller consists of multiple agents, so the action aₜ can be expressed as:

$${a}_{t} = \{ {a}_{v} , {a}_{p} \} .$$

In above formula, aᵥ={a₁,a₂}, aₚ={a₃,a₄}. a₁,a₂,a₃,a₄ are action values generated by the Actor network.

$${vsl}_{T} = \frac{{a}_{v} + 1}{2} \times ( ( v s {l}_{T - 1} + v ) - ( v s {l}_{T - 1} - v ) ) + ( v s {l}_{t - 1} - v ) ,$$

where aᵥ represents the action value related to the speed limit, vsl_{T-1} is the speed limit value of the previous control cycle T−1. v is a fixed value representing the speed increment or decrement each time. The set aₚ is a two-dimensional vector representing the starting and ending positions of the moving bottleneck zone. The starting or ending positions of the moving bottleneck controlled can be expressed as: aₚ×(pₘₐₓ−pₘᵢₙ)+pₘᵢₙ.

In above formula, pₘₐₓ is the farthest distance for the starting or ending control position, and pₘᵢₙ is the nearest distance for the starting or ending control position.

In step (S4), considering safety and traffic flow characteristics, the following two constraints are imposed on the application of the MVSL strategy.

1. To ensure safety and traffic efficiency, the optimal speed limit of MVSL must be below a maximum value (80 km/h) and above a minimum value (30 km/h).

2. For the safe operation of the MVSL strategy, the speed difference between two consecutive time steps shall not exceed 10 km/h.

In step (S4), the reward function ensures that agents are incentivized or disincentivized to perform specific actions based on environmental demands, thereby guiding them to effectively resolve traffic issues. To enhance traffic efficiency, the MVSL controller utilizes the average normalized speed in the bottleneck area as part of the traffic efficiency improvement, considering the average speed of all vehicles in the bottleneck area at the current time step t. For safety considerations, a time-to-collision (TTC) calculation method is introduced. TTC for a single vehicle i at time step t can be expressed as:

$$TTC = \{ \begin{matrix}\frac{{x}_{i - 1} - {x}_{i} - L}{{v}_{i} - {v}_{i - 1}} , & if {v}_{i} ( t ) > {v}_{i - 1} ( t ) \\ ∞ , & if {v}_{i} ( t ) \leq {v}_{i - 1} ( t )\end{matrix} . \qquad ( 1 )$$

Within each time step t, if the TTC of any vehicle i is less than the set threshold TTC′, then the TTC of that vehicle i will be included in the calculation of the safety reward function.

$$T T C = \frac{{\sum }_{i}^{{N}_{s}} T T {C}_{i}}{{N}_{s}} ∀ 0 < T T {C}_{i} ( t ) \leq {TTC}^{′} .$$

Nₛ denotes the number of vehicles within the bottleneck area whose TTC is below the threshold TTC′. The average normalized T̅T̅C̅ within control period Tis calculated as follows:

$$\overline{TTC} = \frac{{\sum }_{i}^{{N}_{s}} T T {C}_{i}}{{N}_{s} \times T \times {TTC}^{′}} .$$

The objective of the MVSL controller is to maximize traffic efficiency while ensuring road safety. Therefore, the hybrid reward function can be expressed as:

$$reward = w \times \overline{V} + ( 1 - w ) \times \overline{TTC} .$$

The traffic efficiency weight w is set to 0.7.

In step (S5), the training process includes the following steps.

Step 5-1: For all agents u, the parameters θ^{u} of the Critic network Q^{w}^{^{u}} and the Actor network π^{u} are initialized.

Step 5-2: The parameters

$${π}_{o l d}^{u}$$

of the current policy is used by setting

$${π}_{o l d}^{u} ← {θ}^{u} ,$$

and the parameters Q̅^{w}^{^{u}} of the target Critic network is initialized by setting w̅^{u}←w^{u}.

Step 5-3: The experience buffer D is initialized.

Step 5-4: For iteration i=1, 2, . . . , L, this step represents the outermost main loop, typically representing the total number of major iterations for the entire training process. Each iteration i generally includes one complete policy evaluation and update process. This is the highest-level loop of the algorithm.

Step 5-41: State S1 is initialized.

Step 5-42: For an episode t=1, 2, . . . , T, within each episode, the agent selects actions based on the current policy, observes environmental feedback, and collects experience data (state, action, reward, next state, etc.). T denotes the number of time steps within a single episode, representing the number of the agent's actions within the environment.

Step 5-421: Each agent u executes an action according to the current policy

$${π}_{o l d}^{u} ( {a}_{t}^{u} \vert {z}_{t}^{u} ) .$$

Step 5-422: The reward rₜ and the next state sₜ₊₁ are obtained.

Step 5-5: For each agent u, the trajectory

$${τ}^{u} = {\{ {z}_{t}^{u} , {a}_{t}^{u} , {r}_{t} \}}_{t = 1}^{T}$$

is obtained.

Step 5-6:

$${{\hat{Q}}^{u} ( {s}_{t} , {a}_{t} )}_{t = 1}^{T}$$

is calculated.

Step 5-7: The advantage function

$${\hat{A}}^{u} {( {s}_{t}^{u} , {a}_{t}^{u} )}_{t = 1}^{T}$$

is calculated.

Step 5-8: The data

$$\{ {z}_{t}^{u} , {a}_{t}^{u} , {\hat{Q}}^{u} ( {s}_{t} , {a}_{t} ) , {\hat{A}}^{u} ( {s}_{t}^{u} , {a}_{t}^{u} ) \}$$

are stored into the experience buffer D.

Step 5-9: For k=1, 2, . . . , K, K denotes the batch size for parameter updates, representing multiple parameter updates within each major iteration using the same batch of data to enhance algorithm stability and efficiency. This represents a further refinement loop within each major iteration, typically employed to optimize model parameters. After collecting sufficient empirical data, this loop is used to update the parameters of the policy network and value network multiple times.

Step 5-91: The data sequence is renumbered.

Step 5-92:

$$For j = 0 , 1 , … , \frac{T}{B} - 1 .$$

Step 5-921: The data set Dⱼ is selected

$${D}_{j} = {\{ {z}_{i}^{u} , {a}_{i}^{u} , {\hat{Q}}^{u} ( {s}_{i} , {a}_{i} ) , {\hat{A}}^{u} ( {s}_{i}^{u} , {a}_{i}^{u} ) \}}_{i = j B + 1}^{( j + 1 ) B} .$$

Step 5-922: For u=1, 2, . . . , N:

Step 5-9221:

$$Δ {θ}^{u} = \frac{1}{B} {\sum }_{i = 1}^{B} \{ {∇}_{{θ}^{u}} f ( r i ( {θ}^{u} ) , {Â}^{u} ( {s}_{i}^{u} , {a}_{i}^{u} ) ) \} ;$$

Step 5-9222:

$$Δ {w}^{u} = \frac{1}{B} {\sum }_{i = 1}^{B} \{ {∇}_{{w}^{u}} {( {\hat{Q}}^{u} ( {s}_{i} , {a}_{i} ) - {Q}^{{w}^{u}} ( {s}_{i} , {a}_{i} ) )}^{2} \} ;$$

Step 5-9223: The parameter θ^{u} is updated using the Adam optimizer by applying gradient ascent.

Step 5-9224: The parameter w^{u} is updated using the Adam optimizer by applying gradient descent.

### Experimental Example

The experiment was conducted in simulation of urban mobility (SUMO), with the scenario based on the UK M25 motorway. The roadway included a control zone, a bottleneck area, a single-entrance ramp area, and a downstream area. The upstream control zone had a length of 7.5 km long, the bottleneck area had a length of 1 km, the single-entrance ramp area had a length of 500 m, and the downstream area had a length of 2 km.

Considering vehicle diversity, vehicle types were defined individually. HDVs were categorized into three distinct types, while CAVs formed one category. The lane-changing model employed default LC2013 model in SUMO. The longitudinal car-following behavior of CAVs followed the IDM. In the simulation, 80% of the vehicles were cars with a length of 3.5 m, while 20% were trucks with a length of 7 m.

Based on 24-hour traffic flow data from Feb. 25 to Mar. 25, 2024, as a reference, the experiment focused on the one-hour period from 17:00 to 18:00 during the evening commute, totaling 3600 seconds. To simulate real traffic conditions, traffic flow inputs were updated every 600 seconds, with specific vehicle introduction values shown in FIGS. 2a and 2b, including main lane and ramp flows. The main lane flow included CAVs and HDVs, while the ramp flow primarily included HDVs.

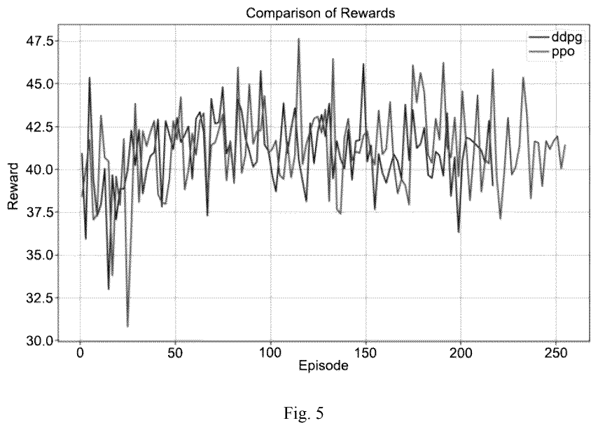

The proposed MAPPO-MVSL strategy adjusted the speed limits in increments or decrements of 10 km/h. The speed limit values included: [30, 40, 50, 60, 70, 80] km/h. To optimize the training process, the hyperparameters must be adjusted accordingly. The hyperparameter configuration used for the MAPPO-MVSL strategy was shown in Table 2. The performance of the proposed MAPPO-MVSL was compared with that of deep deterministic policy gradient (DDPG)-MVSL. Both MAPPO-MVSL and DDPG-MVSL were trained for 250 episodes, and the training reward curves were shown in FIG. 5. During training, the reward value fluctuated around 42.5.

TABLE 2
MAPPO hyperparameter settings

| Hyperparameter | Value |
|---|---|
| Number of training episodes | 250 |
| Epochs per update | 15 |
| Learning rate | 0.0005 |
| GAE parameter | 0.95 |
| Time steps per update | 15 |
| Number of agents | 3 |
| Hidden layer activation function | Sigmoid |
| Discount factor | 0.99 |
| Clipping parameter | 0.2 |

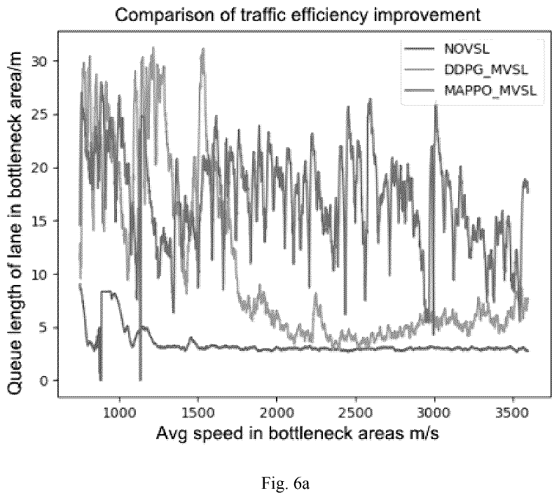

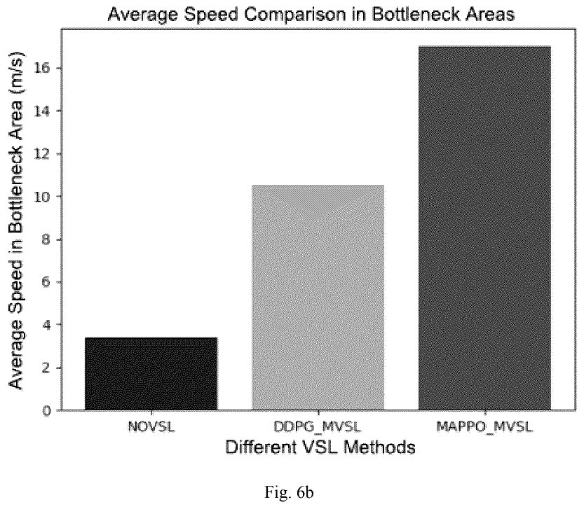

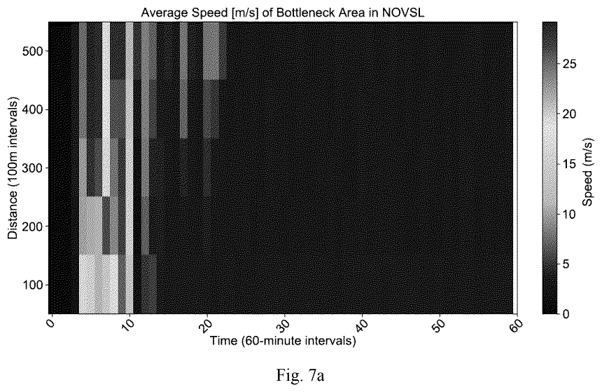

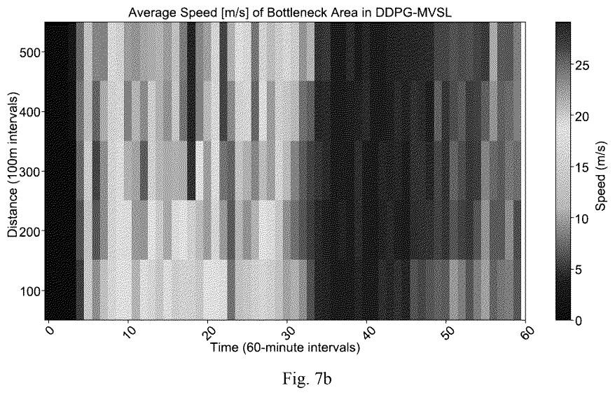

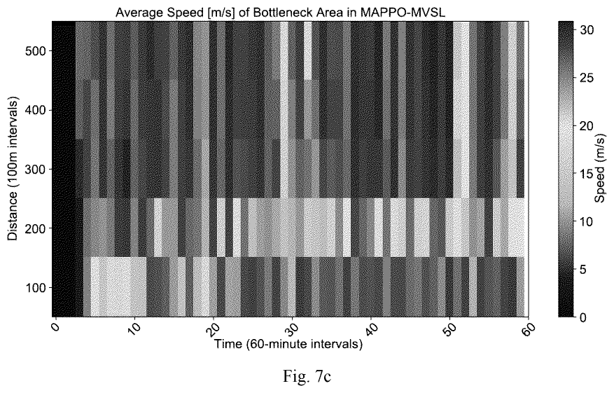

In FIGS. 6a and 6b, the constructed traffic scenario exhibited severe congestion in the merging area. MAPPO-MVSL demonstrated more efficient optimization within the bottleneck area, with smaller speed fluctuations over the control cycles. The histogram in FIG. 6b indicated that MAPPO-MVSL improved traffic efficiency by approximately 40% compared to DDPG-MVSL. For further analysis, FIGS. 7a-7c presented the temporal evolution of speed heatmaps within 100-meter intervals in the bottleneck area. It can be observed that MAPPO-MVSL significantly increased the average speed across different sections of the bottleneck area.

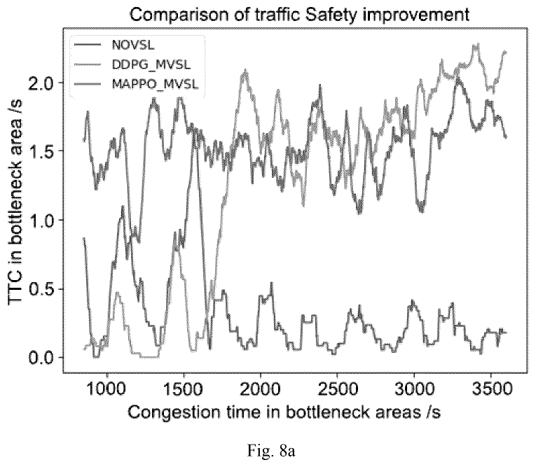

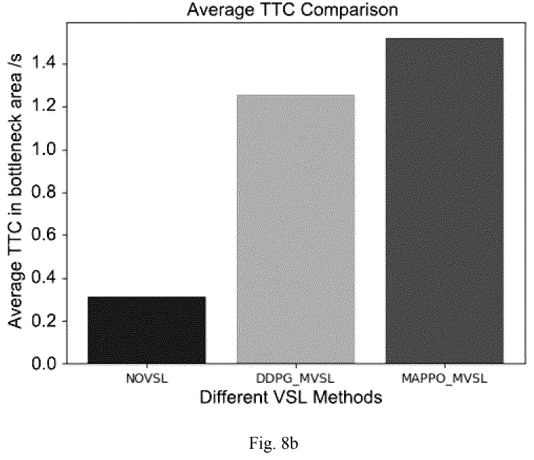

In FIGS. 8a and 8b, a large influx of vehicles merging from the on-ramp into the main lane disrupted normal traffic flow in the inner lanes of the main lane, frequently causing stop-and-go conditions and high collision risks. MAPPO-MVSL exhibited superior safety performance, increasing the average time-to-collision per vehicle by approximately 16%.

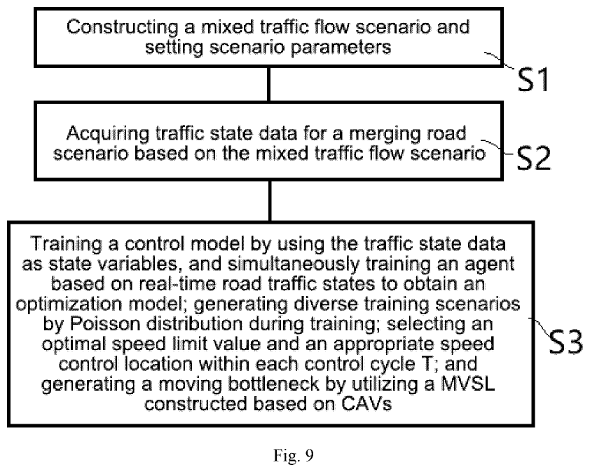

In this embodiment, as shown in FIG. 9, the present disclosure provides the moving bottleneck active construction-based speed limit control method that considers the mixed traffic flow and is based on multi-agent deep reinforcement learning. If implemented in the form of software functional modules and sold or used as standalone products, the method may be stored in a computer-readable storage medium.

In another embodiment, the present disclosure further provides an active control system for variable speed limits on highways, including a scenario construction module, a traffic state acquisition module, and a control module.

The scenario construction module is configured to construct the mixed traffic flow scenario considering driver individuality and set scenario parameters.

The traffic state acquisition module is configured to acquire traffic state data for the merging road scenario based on the mixed traffic flow scenario.

The control module is configured to utilize the acquired traffic state data as state variables to train the control model, while simultaneously training the agent (namely the control model) based on real-time road traffic state to obtain the optimization model. During training, diverse training scenarios are generated via Poisson distribution. Within each control cycle T, the optimal speed limit value and appropriate speed control location are selected, and the moving bottleneck is generated using the MVSL built upon CAVs.

In another embodiment, the present disclosure further provides a terminal device including a processor and a memory. The memory is configured to store a computer program including program instructions. The processor is configured to execute the program instructions stored in the computer storage medium. The processor may be a central processing unit (CPU), or other general-purpose processors, a digital signal processor (DSP), application specific integrated circuits (ASICs), field-programmable gate arrays (FPGAs), or other programmable logic devices, discrete gates or transistor logic devices, discrete hardware components. The processor serves as a computing core and a control core of the terminal, being suitable for implementing one or more instructions. Specifically, the processor is adapted to load and execute one or more instructions to implement the corresponding method or corresponding functions. The processor described in the disclosure can be used for executing the active control method for variable speed limits on highways.

In another embodiment, the present disclosure further provides a storage medium, specifically a computer-readable storage medium (memory). The computer-readable storage medium is a memory device in the terminal device to store programs and data. It can be understood that the computer-readable storage medium herein may include built-in storage medium of the terminal device, and may also include expandable storage media supported by the terminal device. The computer-readable storage medium provides storage space that stores an operating system of the terminal. Furthermore, the storage space also stores one or more instructions suitable for loading and executing by the processor. These instructions may correspond to one or more computer programs (including program code). It should be noted that the computer-readable storage medium herein may be high-speed random access memory (RAM) or non-volatile memory, such as at least one disk storage device. One or more instructions stored in the computer-readable storage medium may be loaded and executed by a processor to implement the corresponding steps of the active control method of variable speed limits on highways described in the above embodiments.

It could be understood that the embodiments of the present disclosure may be provided as methods, systems, or computer program products. Therefore, the present disclosure may be in the form of an entirely hardware embodiment, an entirely software embodiment, or an embodiment combining software and hardware aspects. Moreover, the present disclosure may take the form of a computer program product implemented on one or more computer-usable storage media (including but not limited to disk storage, CD-ROM, and optical storage) containing computer-usable program code.

The present disclosure is described with reference to flowcharts and/or block diagrams of methods, apparatus (systems), and computer program products. It should be understood that each process and/or block in the flowcharts and/or block diagrams, as well as combinations of processes and/or blocks therein, may be implemented by computer program instructions. These computer program instructions may be provided to a processor of a general-purpose computer, a special-purpose computer, an embedded processor, or other programmable data processing devices to produce a machine, such that instructions executed by the processor of the computer or other programmable data processing devices produce apparatus for performing the functions specified in one or more processes of the flowchart and/or one or more blocks of the block diagram.

These computer program instructions may also be stored in a computer-readable storage medium capable of instructing a computer or other programmable data processing devices to operate in a particular manner, such that the instructions stored in the computer-readable storage medium produce manufactures including instruction devices that implement the functions specified in one or more processes of the flowchart and/or one or more blocks of the block diagram.

These computer program instructions may also be loaded onto a computer or other programmable data processing devices to execute a series of steps on the computer or other programmable device, thereby generating computer-implemented processes. The instructions executed on the computer or other programmable device provide steps for implementing the functions specified in one or more processes of the flowchart and/or one or more blocks of the block diagram.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A method for active control of variable speed limits on highways, comprising:
(a) constructing a mixed traffic flow scenario that accounts for driver individuality and setting scenario parameters;
(b) based on the mixed traffic flow scenario, acquiring traffic state data for a merging road scenario, comprising an on-ramp and upstream and downstream areas of a main lane; and
(c) training an agent using the traffic state data as state variables to obtain a speed limit control optimization model, wherein diverse training scenarios are generated by Poisson distribution during training, an optimal speed limit value and an appropriate speed control location are selected within each control cycle T, and a moving bottleneck is generated using a moving bottleneck variable speed limit (MVSL) constructed based on connected and autonomous vehicles (CAVs).

2. The method of claim 1, wherein density and flow data in a merging area are acquired based on the mixed traffic flow scenario to plot a flow-density diagram, which is used as a basis for determining traffic congestion in road sections within the merging area.

3. The method of claim 1, wherein traffic state data of an entire roadway are acquired by using a road network perception module, the road network perception module comprises an area detector, a point detector, and a cloud control center; the area detector and the point detector are configured to receive vehicle information and road status information, and to upload the vehicle information and road status information to the cloud control center; and the cloud control center is configured to convert list data into an array format and transmit the array format to a control model.

4. The method of claim 1, wherein the traffic state data comprises vehicle travel paths, the number of lanes, and traffic volume, and the vehicle travel paths comprise two paths: a path on the main lane and a path from the on-ramp to the main lane.

5. The method of claim 1, wherein step of “the optimal speed limit value and the appropriate speed control location are selected within each control cycle T” comprises:
identifying, at a starting position of a control zone, leading CAVs in different lanes that satisfy predetermined conditions; and
instructing two of the leading CAVs to travel according to fixed speed limit values v_{TV} and v_{OV}.

6. The method of claim 1, wherein the speed limit control optimization model comprises a hybrid reward function considering traffic efficiency and safety, expressed as reward=w×V⁻+(1−w)×(TTC)⁻, wherein w represents a weight for traffic efficiency, V⁻ represents an average normalized speed in a bottleneck area, and (TTC)⁻ represents an average normalized time-to-collision of vehicles in the bottleneck area.

7. The method of claim 1, wherein during training of the speed limit control optimization model, a Critic network and Actor networks are constructed; wherein one Critic network is provided, and the number of the Actor networks are three, and an activation function of each Actor network is modified to a Tanh function to limit an action value output range to [−1, 1];
wherein road state information is input to the Critic network; within each control cycle T, each independent agent makes a decision control by observing local state; a centralized Critic network is configured to employ a normalized advantage function estimation method to estimate a common action based on reward values obtained from action trajectories of each agent during centralized training; and each agent i selects an optimal action
$${a}_{T + 1}^{i}$$
for a next control cycle T+1 by inputting a state value estimated by the Critic network into a corresponding Actor network.

8. A system for active control of variable speed limits on highways, comprising:
a scenario construction module;
a traffic state acquisition module; and
a control module;
the scenario construction module is configured to construct a mixed traffic flow scenario that accounts for driver individuality and set scenario parameters;
the traffic state acquisition module is configured to acquire traffic state data for a merging road scenario comprising an on-ramp and upstream and downstream areas of a main lane based on the mixed traffic flow scenario; and
the control module is configured to train an agent using the traffic state data as state variables to obtain a speed limit control optimization model, wherein diverse training scenarios are generated by Poisson distribution during training, an optimal speed limit value and an appropriate speed control location are selected within each control cycle T, and a moving bottleneck is generated using a MVSL constructed based on CAVs.

9. A computer device, comprising:
a memory;
a processor, and
a computer program;
wherein the computer program is stored in the memory and configured to be operated on the processor; and the processor is configured to execute the computer program to implement the method of claim 1.

10. A computer-readable storage medium, wherein a computer program is stored on the computer-readable storage medium; and the computer program is configured to be executed by a processor to implement the method of claim 1.
